(19) United States
(12) Patent Application Publication
(10) Pub. No.: US 2025/0321008 A1
(43) Pub. Date: Oct. 16, 2025

(54) COOKER

(71) Applicant: SAMSUNG ELECTRONICS CO., LTD., Suwon-si (KR)

(72) Inventors: Wangi PARK, Suwon-si (KR); Jaemin PARK, Suwon-si (KR)

(73) Assignee: SAMSUNG ELECTRONICS CO., LTD., Suwon-si (KR)

(21) Appl. No.: 19/250,267

(22) Filed: Jun. 26, 2025

Related U.S. Application Data
(63) Continuation of application No. PCT/KR2023/019780, filed on Dec. 4, 2023.

(30) Foreign Application Priority Data
Jan. 12, 2023 (KR) 10-2023-0004993
Feb. 20, 2023 (KR) 10-2023-0022367

(51) Int. Cl. F24C 15/02; E05F 3/20

(52) U.S. Cl. CPC F24C 15/023; E05F 3/20; E05Y 2201/11; E05Y 2800/414; E05Y 2900/308

(57) ABSTRACT

A cooking apparatus including a main body forming a cooking compartment; and a door configured to be rotatable to open and close the cooking compartment, the door including: a door frame, a door hinge installed on the door frame to connect the door and the main body, the door hinge including a hinge damper to attenuate a rotation speed of the door, and a thermal resistance member disposed between the hinge damper and the door frame to protect the hinge damper from heat of the cooking compartment.

### CROSS-REFERENCE TO RELATED APPLICATIONS

This application is a continuation application of International Application No. PCT/KR2023/019780, filed on Dec. 4, 2023, which is based on and claims the benefit of Korean Patent Application Number 10-2023-0004993, filed on Jan. 12, 2023, and Korean Patent Application Number 10-2023-0022367, filed on Feb. 20, 2023, the disclosures of which are incorporated by reference herein in their entireties.

### TECHNICAL FIELD

The present disclosure relates to a cooking apparatus including a door.

### BACKGROUND ART

An oven is a cooking apparatus that cooks food by including a cooking compartment, a heating device that applies heat to the cooking compartment, and a circulation fan that circulates the heat generated by the heating device within the cooking compartment.

The ovens are apparatuses that seal and heat food to cook, and may be classified into electric, gas, and electronic types depending on their heat source. Electric ovens use electric heaters as their heat source, while gas ovens use heat from gas as their heat source and microwave ovens use heat from frictional heat from water molecules due to high frequency as their heat source.

The oven includes a main body having an exterior appearance and an open front surface to form a cooking compartment, into which food to be cooked is placed, and a door installed on the front surface of the main body to selectively open and close the cooking compartment.

### DISCLOSURE

An embodiment of the present disclosure is directed to providing a cooking apparatus capable of protecting a door hinge.

An embodiment of the present disclosure is directed to providing a cooking apparatus capable of reducing a speed at which heat of a cooking compartment is transferred to a door hinge.

An embodiment of the present disclosure is directed to providing a cooking apparatus capable of preventing damage to a hinge damper.

Additional aspects of embodiments of the disclosure will be set forth in part in the description which follows and, in part, will be apparent from the description, or may be learned by practice of the presented embodiments.

According to an embodiment of the disclosure, a cooking apparatus includes a main body forming a cooking compartment; and a door configured to be rotatable to open and close the cooking compartment, the door including: a door frame, a door hinge installed on the door frame to connect the door and the main body, the door hinge including a hinge damper to attenuate a rotation speed of the door, and a thermal resistance member disposed between the hinge damper and the door frame to protect the hinge damper from heat of the cooking compartment.

According to an embodiment of the disclosure, the door frame may include a front frame, and a rear frame at a rear side of the front frame so as to be adjacent to the cooking compartment when the door closes the cooking compartment. The thermal resistance member may be disposed between the hinge damper and the rear frame.

According to an embodiment of the disclosure, the door hinge may include a hinge housing surrounding the hinge damper. The thermal resistance member may be disposed between the hinge housing and the rear frame.

According to an embodiment of the disclosure, the hinge housing may include a rear surface facing a direction of the cooking compartment when the door closes the cooking compartment. The thermal resistance member may be disposed between the rear surface of the hinge housing and the rear frame.

According to an embodiment of the disclosure, the thermal resistance member may include a first surface, and a second surface located opposite to the first surface. The first surface may be in contact with the rear surface of the hinge housing. The second surface may be in contact with the rear frame.

According to an embodiment of the disclosure, the thermal resistance member may include a hollow portion, and a body portion forming the hollow portion.

According to an embodiment of the disclosure, the body portion may include an edge corresponding to and edge of the rear surface of the hinge housing.

According to an embodiment of the disclosure, the thermal resistance member may be couplable to the hinge housing.

According to an embodiment of the disclosure, the hinge housing may include a guide portion to guide a coupling position of the thermal resistance member to the hinge housing.

According to an embodiment of the disclosure, the thermal resistance member may be couplable to the rear frame.

According to an embodiment of the disclosure, the thermal resistance member may include plastic.

According to an embodiment of the disclosure, the thermal resistance member may be an injection molded member.

According to an embodiment of the disclosure, the door hinge may include a first door hinge, and a second door hinge spaced apart from the first door hinge. The thermal resistance member may include a first thermal resistance member in contact with the first door hinge, and a second thermal resistance member in contact with the second door hinge.

According to an embodiment of the disclosure, the thermal resistance member may be disposed in a space in which the door hinge and the door frame are spaced apart from each other.

### DESCRIPTION OF DRAWINGS

These and/or other aspects of the disclosure will become apparent and more readily appreciated from the following description of embodiments, taken in conjunction with the accompanying drawings listed below.

FIG. 1 is a perspective view illustrating a cooking apparatus according to an embodiment of the present disclosure.

FIG. 2 is a view illustrating a state in which a door of the cooking apparatus according to an embodiment of the present disclosure is open.

FIG. 3 is a cross-sectional view of the cooking apparatus according to an embodiment of the present disclosure.

FIG. 4 is a longitudinal cross-sectional view of the cooking apparatus according to an embodiment of the present disclosure.

FIG. 5 is an exploded perspective view of the door of the cooking apparatus according to an embodiment of the present disclosure.

FIG. 6 is a view illustrating positions in which a hinge and a thermal resistance member of the cooking apparatus according to an embodiment of the present disclosure are arranged.

FIG. 7 is a view illustrating a state in which the hinge and the thermal resistance member are coupled according to an embodiment of the present disclosure.

FIG. 8 is an exploded perspective view of the hinge and the thermal resistance member according to an embodiment of the present disclosure.

FIG. 9 is a perspective view of the thermal resistance member according to an embodiment of the present disclosure.

FIG. 10 is an enlarged cross-sectional view of the cooking apparatus according to an embodiment of the present disclosure.

FIG. 11 is an enlarged-longitudinal cross-sectional view of the cooking apparatus according to an embodiment of the present disclosure.

### MODES OF THE INVENTION

Embodiments described in the disclosure and configurations shown in the drawings are merely examples of the embodiments of the disclosure, and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, numbers, steps, operations, elements, components, or combinations thereof.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In the following detailed description, the terms of “front side”, “upper portion”, “lower portion”, “left side”, “right side” and the like may be defined by the drawings, but the shape and the location of the component is not limited by the term.

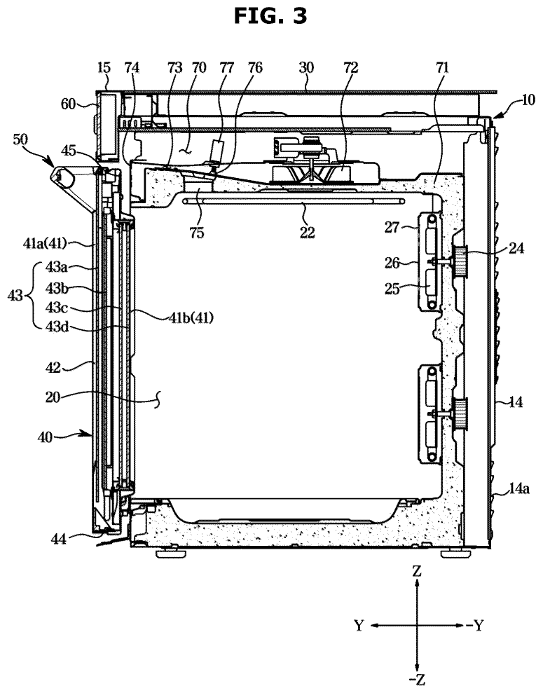

For convenience, a direction in which a door 40 is arranged with respect to a cooking compartment 20 in FIG. 3 is referred to as “front side”. That is, the Y-axis may mean “front” and the −Y-axis may mean “rear”.

Hereinafter exemplary embodiments of the present disclosure will be described in detail with reference to the accompanying drawings.

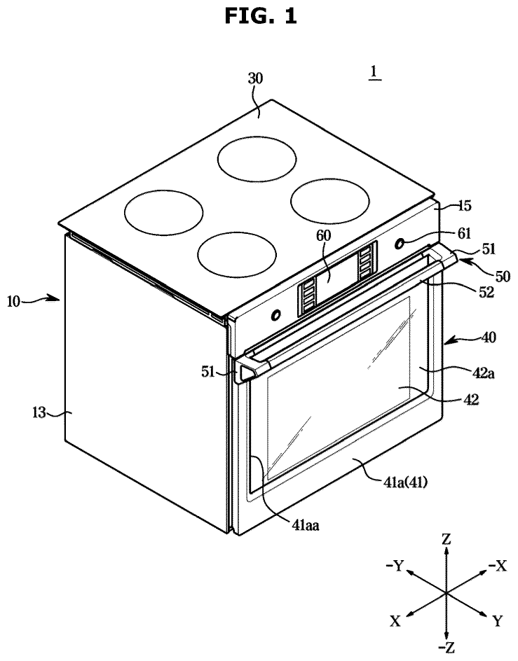

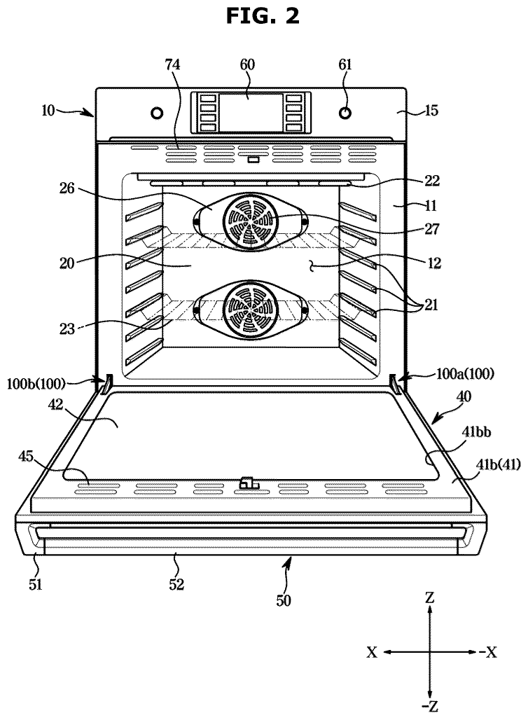

FIG. 1 is a perspective view illustrating a cooking apparatus according to one embodiment of the present disclosure. FIG. 2 is a view illustrating a state in which a door of the cooking apparatus according to one embodiment of the present disclosure is open. FIG. 3 is a cross-sectional view of the cooking apparatus according to one embodiment of the present disclosure.

A cooking apparatus 1 may be an oven 1. Hereinafter for convenience of description, the oven 1 will be used as an example, but the present disclosure is not limited thereto. For example, the cooking apparatus 1 may be a microwave oven, etc.

The oven 1 may include a main body 10 including the cooking compartment 20 located therein, and a cooktop 30 provided on an upper end of the main body 10 and on which a container containing food is placed and heated.

The main body 10 may include a front panel 11 forming a front surface of the main body 10, a side panel 13 forming a side surface of the main body 10, and a rear panel 14 forming a rear surface of the main body 10.

The cooking compartment 20 may be provided in a box shape inside the main body 10, and a front surface of the cooking compartment 20 may be opened to allow food to be taken in and out. An opening 12 corresponding to the cooking compartment 20 with the open front surface may be provided at the front panel 11. The open front surface of the cooking compartment 20 may be opened and closed by the door 40.

A plurality of supports 21 may be provided inside the cooking compartment 20. A rack 23 on which food is placed may be mounted on the plurality of supports 21. The plurality of supports 21 may be formed to protrude from left and right walls of the cooking compartment 20.

A divider (not shown) provided to divide the cooking compartment 20 may be removably mounted on the plurality of supports 21. Particularly, the divider (not shown) may be mounted horizontally in the cooking compartment 20 so as to divide the cooking compartment 20 into a plurality of cooking compartments.

The plurality of cooking compartments 20 may not have to be the same size as each other, and may have different sizes. The divider (not shown) may have an insulating material and may insulate each cooking compartment 20. Accordingly, the cooking compartment 20 may be used in various ways depending on the user's intention.

A heater 22 configured to heat food may be provided in the cooking compartment 20. In the present embodiment, the heater 22 may be an electric heater including an electric resistor. However, unlike the present embodiment, the heater 22 may be a gas heater configured to generate heat by burning gas. That is, the oven 1 according to the embodiment of the present disclosure includes an electric oven and a gas oven.

A circulation fan 25 configured to circulate air in the cooking compartment 20 to evenly heat food, and a circulation motor 24 configured to drive the circulation fan 25 may be provided at a rear portion of the cooking compartment 20. A fan cover 26 provided to cover the circulation fan 25 may be provided in front of the circulation fan 25, and a through-hole 27 may be formed in the fan cover 26 to allow air to flow.

The door 40 may be rotatably coupled to the main body 10 to open and close the cooking compartment 20. The door 40 may be coupled to a front side of the main body 10.

The door 40 may be coupled to a lower side of the main body 10. However, the present disclosure is not limited thereto, and the door 40 may be coupled to the left or right side of the main body 10.

A door hinge 100 may connect the door 40 and the main body 10. The door hinge 100 may rotatably support the door 40 relative to the main body 10.

The door 40 may include a window 42 to allow a cooking process of food inside the cooking compartment 20 to be observed from the outside. Particularly, the door 40 may include a door frame 41 including an opening provided to allow the inside of the cooking compartment 20 to be seen, and the door frame 41 may include a front frame 41a and a rear frame 41b. The front frame 41a may include a front frame opening 41aa for providing the window 42, and the rear frame 41b may include a rear frame opening 41bb.

The door 40 may be provided with a plurality of panels 43 for insulation of the inside of the cooking compartment 20. The plurality of panels 43 may be provided with a transparent material such as glass, which is intended to form the window 42 to allow the inside of the cooking compartment 20 to be seen. Therefore, the plurality of panels 43 may be provided with a transparent material other than glass.

The plurality of panels 43 may include a first panel 43a, a second panel 43b, a third panel 43c, and a fourth panel 43d arranged in the forward and backward directions. A masking portion 42a may be provided in a portion of the first panel 43a, which is arranged at the most front side, to cover a structure inside the door 40 and to prevent light, which illuminates the inside of the cooking compartment 20, from being reflected by the structure inside the door 40 and leaking to the outside. Particularly, the masking portion 42a may be provided on a back surface side of the first panel 43a so as to surround a center portion that forms the window 42. The masking portion 42a may be formed on the back surface of the first panel 43a by a printing method or the like.

A door inlet 44 configured to draw air into the inside of the door 40 may be provided at a lower end of the door 40. Outside air that is drawn in from the lower end of the door 40 may heat exchange with the heat transferred from the cooking compartment 20 while the air moves to the upper side of the door 40, and then the air may be discharged through a door outlet 45 provided in the rear frame 41b located at the rear side of the door 40. With the configuration, the present disclosure may cool the heat inside the door 40 through the circulation of air.

A handle 50 that may be gripped by a user to easily open and close the door 40 may be provided at an upper portion of the front surface of the door 40. On the other hand, when the door 40 is hinge-coupled to the left or right side of the main body 10, the handle 50 may be provided correspondingly on the right or left side of the front surface of the door 40.

The handle 50 may protrude forward from the front surface of the door 40 by a predetermined length. That is, the handle 50 may include a pair of handle support portions 51 extending forward from the front surface of the door 40, and a handle extension 52 connecting the pair of handle support portions 51.

However, the present disclosure is not limited thereto, and the door 40 may not include the handle 50. For example, the door 40 may be configured to be open or closed based on a user pressing the door 40 toward the main body 10. Alternatively, the door 40 may be configured to be open or closed automatically by electronic control.

A display module 60 configured to display various operation information of the oven 1 and configured to receive an operation command from a user may be provided on the upper front surface of the front panel 11. The display module 60 may be mounted on an electrical compartment cover 15, electronic

Additionally, a manipulator 61 may be provided on an oven cover 15 to additionally operate the oven 1.

The oven 1 includes an electrical compartment 70 provided to accommodate electrical components configured to control the operation of various components, including the display module 60. The electrical compartment 70 is provided above the cooking compartment 20. An insulating material 71 may be provided between the electrical compartment 70 and the cooking compartment 20 to insulate the electrical compartment 70 and the cooking compartment 20 so as to prevent heat from the cooking compartment 20 from being transferred to the electrical compartment 70.

In addition, the insulating material 71 may be provided to cover the entire outside of the cooking compartment 20 to prevent the heat of the cooking compartment 20 from being transferred to the outside of the oven 1, as well as the electrical compartment 70 and the cooking compartment 20.

The oven 1 includes a cooling structure configured to cool the electrical compartment 70 by circulating air around the cooking compartment 20. The cooling structure of the oven 1 may include a cooling fan unit 72 configured to circulate air, and a cooling flow path 73 provided to discharge air drawn in by the cooling fan unit 72 to the front side of the oven 1.

That is, air outside the main body may be drawn into the electrical compartment 70 through a through-hole 14a formed in the rear panel 14, and the air drawn into the electrical compartment 70 may cool the electrical components while moving inside the electrical compartment 70. The air may be finally discharged to the front side of the oven 1 through an outlet 74 along the cooling flow path 73.

A portion of the air in the cooking compartment 20 may be drawn into the cooling flow path 73 through a discharge flow path 75 and discharged to the front side of the oven 1. In addition, a bypass hole 76 may be additionally formed to introduce a portion of the air, which flows from the cooling flow path 73 to the outlet 74, into the discharge flow path 75. The bypass hole 76 may be opened and closed by an opening and closing device 77, and an amount of air discharged from the cooking compartment 20 to the cooling flow path 73 may be controlled according to the opening and closing of the bypass hole 76.

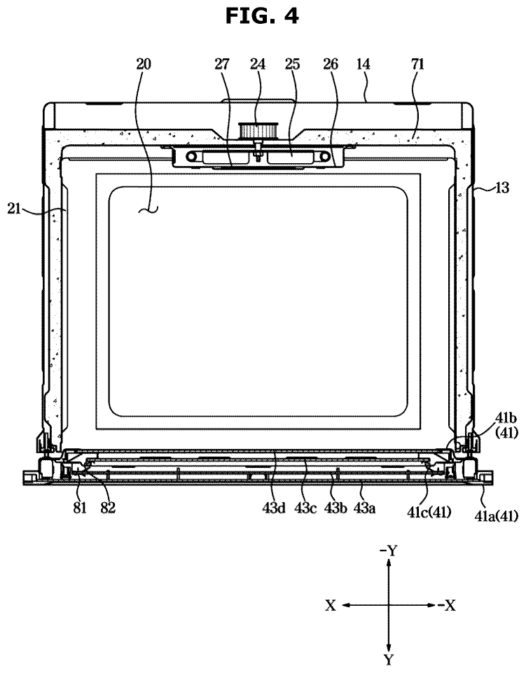

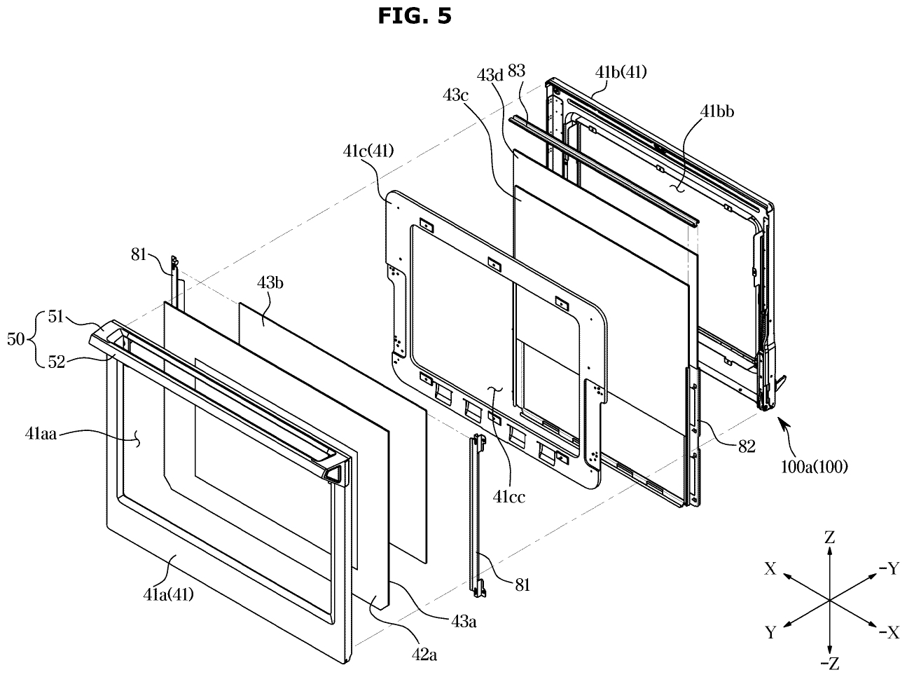

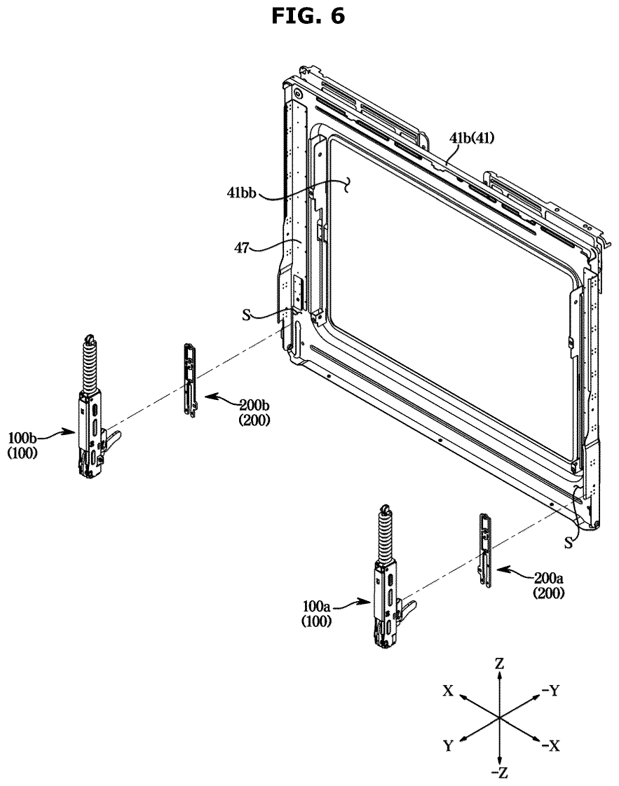

FIG. 4 is a longitudinal cross-sectional view of the cooking apparatus according to one embodiment of the present disclosure. FIG. 5 is an exploded perspective view of the door of the cooking apparatus according to one embodiment of the present disclosure. FIG. 6 is a view illustrating positions in which a hinge and a thermal resistance member of the cooking apparatus according to one embodiment of the present disclosure are arranged.

The door 40 may include the door frame 41. The door frame 41 may form an exterior of the door 40. The door frame 41 may be provided to include the opening forming the window 42. The door frame 41 may be provided to support structures arranged inside the door.

The door frame 41 may include metal.

The door frame 41 may include the front frame 41a, a middle frame 41c, and the rear frame 41b.

The front frame 41a may form the front surface of the door 40. The front frame 41a may be provided to fix the first panel 43a. The front frame 41a may include the front frame opening 41aa forming the window 42 in a center portion thereof.

The middle frame 41c may be disposed at the rear of the front frame 41a. The middle frame 41c may be disposed at the front of the rear frame 41b. The middle frame 41c may be disposed between the front frame 41a and the rear frame 41b.

A front surface of the middle frame 41c may be arranged to face the front frame 41a, and a rear surface of the middle frame 41c may be arranged to face the rear frame 41b. The middle frame 41c may include a middle frame opening 41cc forming the window 42 in a center portion thereof.

The rear frame 41b may be disposed at the rear of the front frame 41a and/or the middle frame 41c. The rear frame 41b may form a rear surface of the door 40. The door outlet 45 may be formed in the rear frame 41b.

The rear frame 41b may be disposed adjacent to the cooking compartment 20. The front frame 41a, the middle frame 41c, and the rear frame 41b may be sequentially disposed adjacent to the cooking compartment 20.

When the door 40 closes the cooking compartment 20, i.e., when the door 40 is closed, the rear frame 41b may come into contact with the main body 10. The rear frame 41b may come into contact with the front panel 11.

The first panel 43a may be provided to be fixed to the front frame 41a, and the second panel 43b may be fixed to the front surface of the middle frame 41c by a first fixing member 81. The first fixing member 81 may be force-fitted to both left and right ends of the second panel 43b, and may be fixed to the middle frame 41c by a separate fastening member.

The third panel 43c and the fourth panel 43d may be inserted into a second fixing member 82 surrounding left, right, and lower ends of the third panel 43c and the fourth panel 43d, and upper ends of the third panel 43c and the fourth panel 43d may be covered by a third fixing member 83 to allow the third panel 43c and the fourth panel 43d to be fixed to the back surface of the middle frame 41c.

The door 40 may include the door hinge 100. The door hinge 100 may be installed in the door frame 41. The door hinge 100 may be coupled to the door frame 41.

The door hinge 100 may be installed at a lower portion of the door frame 41. The door hinge 100 may include a first door hinge 100a, and a second door hinge 100b spaced apart from the first door hinge 100a. The first door hinge 100a and the second door hinge 100b may be arranged left and right at both ends of the door frame 41.

The door hinge 100 may be installed in the rear frame 41b. The door hinge 100 may be disposed in a receiving space S of the rear frame 41b. The receiving space S may be formed in the front of the rear frame 41b. The receiving space S may be formed between the rear frame 41b and the front frame 41a. The receiving space S may be formed by a rear frame front surface 47 and a rear frame side surface.

The door 40 may include a thermal resistance member 200. The thermal resistance member 200 may be installed in the door frame 41. The thermal resistance member 200 may be disposed between the door hinge 100 and the door frame 41.

The thermal resistance member 200 may be installed in the rear frame 41b. The thermal resistance member 200 may be disposed in the receiving space S of the rear frame 41b. The thermal resistance member 200 may be disposed between the door hinge 100 and the rear frame 41b.

The thermal resistance member 200 may be arranged to be in contact with the rear frame front surface 47. A first surface 201 of the thermal resistance member 200 may be in contact with the door hinge 100, and a second surface 202 arranged on the opposite side to the first surface 201 may be in contact with the rear frame front surface 47.

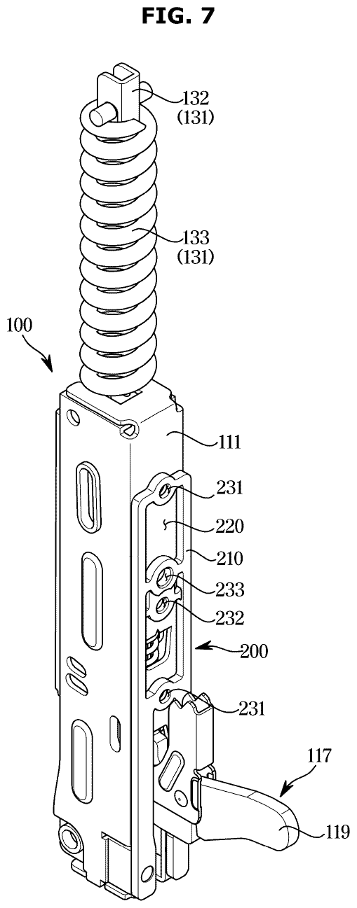

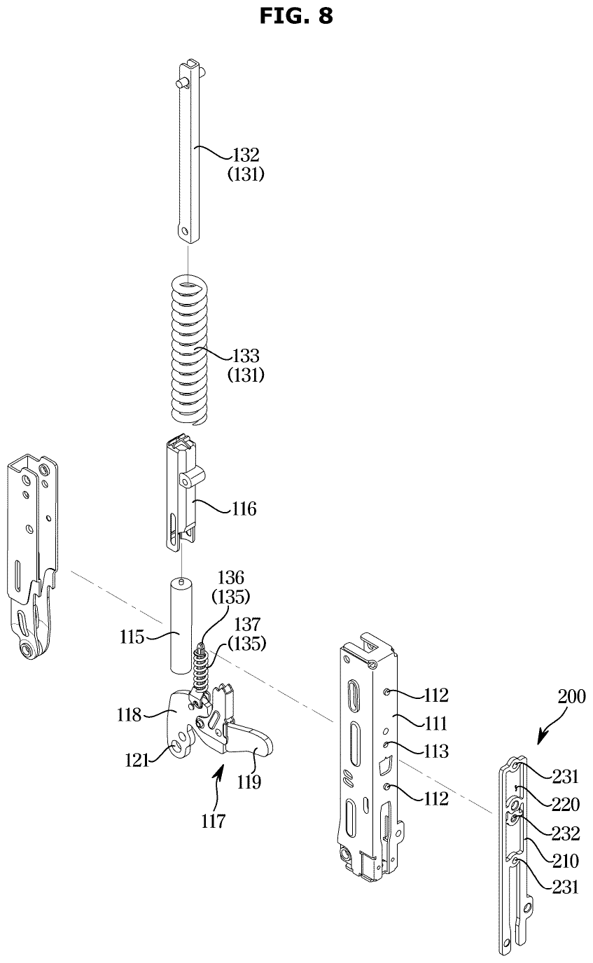

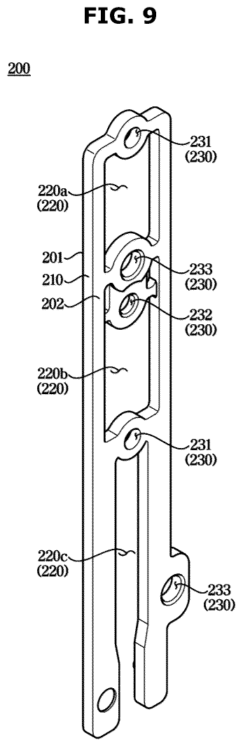

FIG. 7 is a view illustrating a state in which the hinge and the thermal resistance member are coupled according to one embodiment of the present disclosure. FIG. 8 is an exploded perspective view of the hinge and the thermal resistance member according to one embodiment of the present disclosure. FIG. 9 is a perspective view of the thermal resistance member according to one embodiment of the present disclosure.

The door hinge 100 may include a hinge housing 110. The hinge housing 110 may be coupled to the door 40. The hinge housing 110 may be fixed to the door frame 41 and may be configured to rotate together with the door 40 when the door 40 opens and closes the cooking compartment 20.

For example, the hinge housing 110 may be fixed to the rear frame 41b by screw fastening. However, the present disclosure is not limited thereto, and the hinge housing 110 may be fixed to the door 40 by various methods.

The hinge housing 110 may form an internal space. Various components of the door hinge 100 may be disposed in the internal space of the hinge housing 110. For example, a hinge damper 115, a second elastic member 135, a hinge link 117, etc. may be disposed in the internal space.

The hinge housing 110 may be rotatably supported by the hinge link 117. The hinge housing 110 may be configured to be rotatable with respect to a door rotating shaft 121. The door rotating shaft 121 may function as a rotating shaft of the door 40. The hinge housing 110 and the hinge link 117 may be coupled by the door rotating shaft 121. The door rotating shaft 121 may penetrate the hinge housing 110 and the hinge link 117. The door rotating shaft 121 may couple a lower portion of the hinge housing 110 and a lower portion of the hinge link 117.

The hinge housing 110 may be formed of metal. However, the material of the hinge housing 110 is not limited thereto.

The door hinge 100 may include the hinge link 117. The hinge link 117 may connect the main body 10 and the door 40. The hinge link 117 may be coupled to the hinge housing 110. The hinge link 117 may rotatably support the hinge housing 110.

The hinge link 117 may be coupled to the main body 10. Regardless of the opening and closing of the door 40, the main body 10 may maintain a fixed position with respect to the hinge link 117.

The hinge link 117 may include a body coupling portion 119 coupled to the main body 10. The body coupling portion 119 may be inserted into the main body 10.

The hinge link 117 may be coupled to the door 40. The hinge link 117 may be coupled to the hinge housing 110.

The hinge link 117 may include a door coupling portion 118 coupled to the hinge housing 110. The door coupling portion 118 may be inserted into the hinge housing 110. At least a portion of the door coupling portion 118 may be covered by the hinge housing 110.

The door rotating shaft 121 may be provided to penetrate the door coupling portion 118 and the hinge housing 110.

The door hinge 100 may include an elastic system configured to allow efficient rotational movement of the door 40 when the door 40 opens or closes the cooking compartment 20.

The elastic system of the door hinge 100 may include a first elastic member 131.

The first elastic member 131 may be configured to accumulate an elastic force when the door 40 opens the cooking compartment 20 and to provide the elastic force when the door 40 closes the cooking compartment, thereby compensating for the door 40 not being easily closed due to its own weight.

The first elastic member 131 may include a first elastic spring 133 configured to accumulate or provide an elastic force, and a first spring rod 132 supported on the hinge housing 110. The first elastic spring 133 may be arranged to surround an outer circumferential surface of the first spring rod 132.

The elastic system of the door hinge 100 may include a second elastic member 135.

The second elastic member 135 may be configured to provide an elastic force in a direction, in which the door 40 opens, in an initial stage of the operation of opening the cooking compartment 20 at the closed position of the door 40, so as to allow the door 40 to be easily opened.

The second elastic member 135 may include a second elastic spring 137 configured to accumulate or provide an elastic force, and a second spring rod 136 supported on the hinge housing 110. The second elastic spring 137 may be arranged to surround an outer circumferential surface of the second spring rod 136.

The door hinge 100 may include the hinge damper 115, and a damper housing 116 covering the hinge damper 115. The hinge damper 115 may be provided to prevent the door 40 from closing too quickly when the door 40 closes the cooking compartment 20. The hinge damper 115 may be provided to generate a damping force. The hinge damper 115 may be provided to attenuate a moving speed of the door 40.

The damper housing 116 may be provided to surround the hinge damper 115. The hinge damper 115 may be accommodated inside the damper housing 116. The damper housing 116 may be provided to prevent the hinge damper 115 from being exposed to the outside. The damper housing 116 may be provided to cover the hinge damper 115.

The hinge damper 115 and/or the damper housing 116 may be accommodated within the hinge housing 110. The hinge housing 110 may surround and cover the hinge damper 115 and/or the damper housing 116.

The cooking apparatus 1 may include the thermal resistance member 200. The thermal resistance member 200 may include an open or hollow portion 220, and a body portion 210 forming the hollow portion 220.

The body portion 210 may be provided to correspond to the hinge housing 110. The body portion 210 may be provided to correspond to a perimeter of one surface of the hinge housing 110. The body portion 210 may include an edge corresponding to the rear surface 111 of the hinge housing 110.

The body portion 210 may be extended in a substantially rectangular shape. However, the present disclosure is not limited thereto, and the body portion 210 may be extended along various shapes.

The body portion 210 may include the first surface 201, and the second surface 202 disposed on an opposite side of the first surface 201.

The hollow portion 220 may be formed on the inside of the body portion 210. The hollow portion 220 may mean an empty space. The hollow portion 220 may be formed to penetrate the body portion 210.

The hollow portion 220 may be provided in plurality. The hollow portion 220 may include a first hollow portion 220a, a second hollow portion 220b, and a third hollow portion 220c which are spaced apart from each other.

The thermal resistance member 200 may include a coupling portion 230. The coupling portion 230 may be provided to allow the thermal resistance member 200 to be coupled to the door hinge 100 and/or the door frame 41. The coupling portion 230 may be provided to allow the thermal resistance member 200 to be coupled to the hinge housing 110 and/or the rear frame 41b.

The coupling portion 230 may include a first coupling hole 232. The first coupling hole 232 may be provided to allow the thermal resistance member 200 to be coupled to the rear surface 111 of the hinge housing 110. The first coupling hole 232 may be provided so as to correspond to a hinge coupling hole 113 of the rear surface 111 of the hinge housing 110. The thermal resistance member 200 may be coupled to the hinge housing 110 through a screw or the like penetrating the first coupling hole 232 and the hinge coupling hole 113.

The coupling portion 230 may include a second coupling hole 233. The second coupling hole 233 may be provided to allow the thermal resistance member 200 to be coupled to the rear frame 41b. The second coupling hole 233 may be provided so as to correspond to a frame coupling hole of the rear frame 41b. The thermal resistance member 200 may be coupled to the rear frame 41b through a screw or the like penetrating the second coupling hole 233 and the frame coupling hole. A plurality of second coupling holes 233 may be provided.

The coupling portion 230 may include a guide hole 231. The guide hole 231 may be provided to guide a position in which the thermal resistance member 200 is coupled to the hinge housing 110. The guide hole 231 may be provided to correspond to a guide protrusion 112 of the rear surface 111 of the hinge housing 110. The guide hole 231 may be provided to allow the guide protrusion 112 to inserted thereinto. A plurality of guide holes 231 may be provided.

The thermal resistance member 200 may be formed by injection molding. The thermal resistance member 200 may include plastic. However, the present disclosure is not limited thereto, and the thermal resistance member 200 may also include non-ferrous metal, wood, etc.

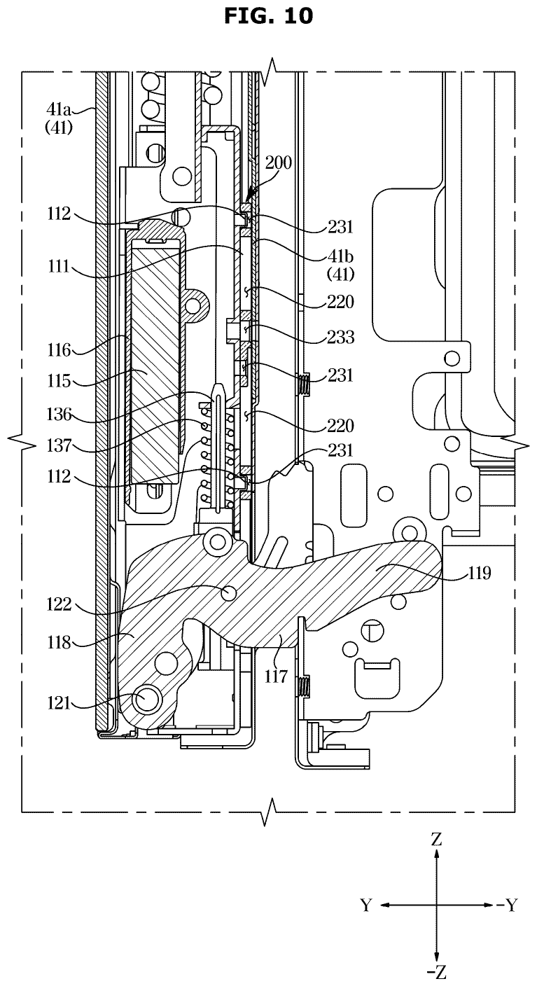

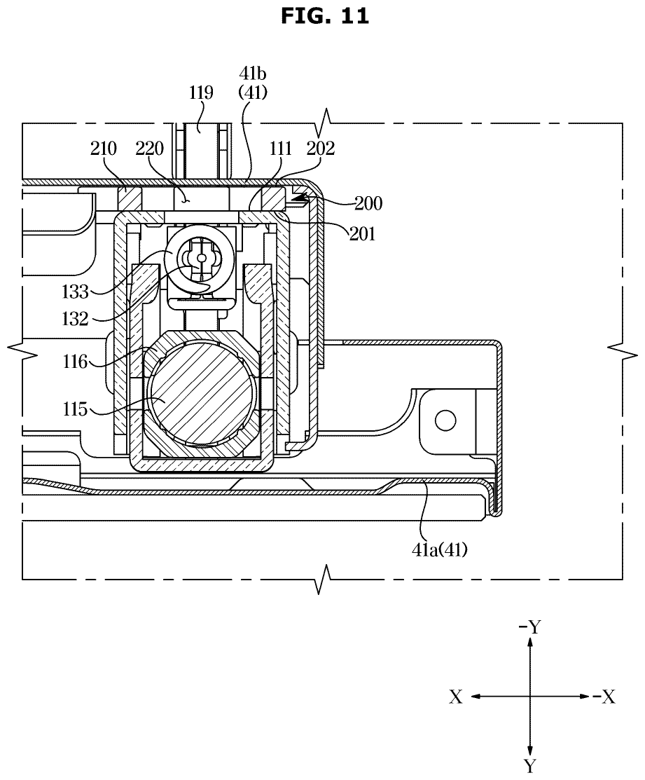

FIG. 10 is an enlarged cross-sectional view of the cooking apparatus according to one embodiment of the present disclosure. FIG. 11 is an enlarged-longitudinal cross-sectional view of the cooking apparatus according to one embodiment of the present disclosure.

When the cooking apparatus 1 is in operation, heat may be generated in the cooking compartment 20. A temperature of the cooking compartment 20 may increase due to the heat generated by the heater 22 inside the cooking compartment 20. Depending on a heating level and/or heating time of the heater 22, an internal temperature of the cooking compartment 20 may increase to 150 to 250 degrees Celsius. For example, the cooking apparatus 1 may control the internal temperature of the cooking compartment 20 according to an oven mode, a direct fire oven mode, a grill mode, an air fry mode, etc., and the inside of the cooking compartment 20 may be maintained at a high temperature of about 200 degrees Celsius. However, the present disclosure is not limited thereto, and the cooking compartment 20 may be maintained at various temperatures.

As the temperature inside the cooking compartment 20 is maintained high, the heat inside the cooking compartment 20 may move to the door hinge 100 installed in the door 40 and be transferred to the hinge damper 115. The hinge damper 115 may be provided to attenuate the moving speed of the door 40. The hinge damper 115 may be vulnerable to heat damage by using the pressure of a fluid, gas, or the like. Accordingly, a damping force of the hinge damper 115 may be reduced as the heat inside the cooking compartment 20 is transferred to the hinge damper 115. In addition, a lifespan of the hinge damper 115 may be reduced.

The door 40 may be disposed adjacent to the cooking compartment 20. Accordingly, heat inside the cooking compartment 20 may be transferred to the door 40. Heat transferred to the rear frame 41b of the door 40 adjacent to the cooking compartment 20 may be transferred to the door hinge 100 installed inside the door 40.

The thermal resistance member 200 may be provided to protect the door hinge 100. The thermal resistance member 200 may be provided to protect the door hinge 100 from external heat. The thermal resistance member 200 may be provided to protect the hinge damper 115 from the heat of the cooking compartment 20. The thermal resistance member 200 may prevent the heat of the cooking compartment 20 from being transferred to the hinge damper 115.

The thermal resistance member 200 may be arranged between the rear frame 41b and the door hinge 100, thereby preventing the heat of the cooking compartment 20 from being directly transferred to the door hinge 100. Particularly, a speed at which the heat of the rear frame 41b is transferred to the door hinge 100 may be reduced.

The thermal resistance member 200 may prevent the door hinge 100 from being in contact with the rear frame 41b. The thermal resistance member 200 may be arranged to allow the door hinge 100 to be spaced apart from the rear frame 41b. The thermal resistance member 200 may be arranged in the space where the door hinge 100 and the rear frame 41b are spaced apart.

The thermal resistance member 200 may include plastic. The thermal resistance member 200 may include a material having a lower thermal conductivity than the rear frame 41b and/or the hinge housing 110.

The thermal resistance member 200 may suppress heat from being transferred to the hinge damper 115 inside the door hinge 100. The hinge damper 115 may be greatly affected by temperature using the pressure of a fluid, gas, etc., and thus the thermal resistance member 200 may prevent heat damage to the hinge damper 115 by preventing heat of the rear frame 41b from being transferred to the hinge damper 115. The thermal resistance member 200 may increase the lifespan of the hinge damper 115.

The thermal resistance member 200 may be provided to allow the first surface 201 of the body portion 210 to be in contact with the hinge housing 110 and to allow the second surface 202 of the body portion 210 to be in contact with the rear frame 41b.

Because the thermal resistance member 200 includes the hollow portion 220, an area in which the thermal resistance member 200 is in contact with the hinge housing 110 and/or the rear frame 41b may be reduced. The hollow portion 220 may be provided to allow heat transfer from the door frame 41 to the hinge housing 110 to be minimized.

The thermal resistance member 200 may be provided to protect the door hinge 100 from external impact. The thermal resistance member 200 may be provided to alleviate impact applied to the door hinge 100 from the door frame 41 as the thermal resistance member 200 is disposed between the door hinge 100 and the door frame 41. The thermal resistance member 200 may be provided to reinforce a rigidity of the door hinge 100 by being attached to the hinge housing 110.

The cooking apparatus 1 according to one embodiment of the present disclosure may include the main body 10 forming the cooking compartment 20, and the door 40 configured to open and close the cooking compartment 20. The door 40 may include the door frame 41, the door hinge 100 installed on the door frame 41 so as to connect the door 40 and the main body 10, and including the hinge damper 115 provided to attenuate a moving speed of the door 40, and the thermal resistance member 200 disposed between the hinge damper 115 and the door frame 41 so as to protect the hinge damper 115 from heat of the cooking compartment 20. According to the present disclosure, the speed at which the heat of the cooking compartment 20 is transferred to the door hinge 100 may be reduced, thereby protecting the door hinge 100 and the hinge damper 115. By preventing thermal damage to the hinge damper 115, the damping force of the hinge damper 115 may be prevented from being impaired. In addition, the lifespan of the hinge damper 115 and the door hinge 100 may be increased.

The door frame 41 may include the front frame 41a, and the rear frame 41b arranged at the rear side of the front frame 41a so as to be disposed adjacent to the cooking compartment 20. The thermal resistance member 200 may be disposed between the hinge damper 115 and the rear frame 41b. According to the present disclosure, the speed, at which heat moving from the cooking compartment 20 to the rear frame 41b is transferred to the door hinge 100, may be reduced.

The door hinge 100 may include the hinge housing 110 surrounding the hinge damper 115. The thermal resistance member 200 may be disposed between the hinge housing 110 and the rear frame 41b. According to the present disclosure, the life span of the hinge damper 115 may be increased by suppressing the heat of the cooking compartment 20 from being transferred to the hinge damper 115. The thermal resistance member 200 may be disposed outside the hinge housing 110, thereby increasing convenience of installation.

The hinge housing 110 may include the rear surface 111 disposed toward the cooking compartment 20. The thermal resistance member 200 may be disposed between the rear surface 111 of the hinge housing 110 and the rear frame 41b. According to the present disclosure, the thermal resistance member 200 may reduce the speed at which heat is transferred to the rear surface 111 of the hinge housing 110 adjacent to the cooking compartment 20.

The thermal resistance member 200 may include the first surface 201, and the second surface 202 located opposite to the first surface 201. The first surface 201 may be disposed to be in contact with the rear surface 111 of the hinge housing 110, and the second surface 202 may be disposed to be in contact with the rear frame 41b. According to the present disclosure, the thermal resistance member 200 may prevent the hinge housing 110 and the rear frame 41b from being in contact with each other, thereby reducing the speed at which heat is transferred.

The thermal resistance member 200 may include the hollow portion 220, and the body portion 210 forming the hollow portion 220. According to the present disclosure, the area where the thermal resistance member 200 is in contact with the door hinge 100 and/or the door frame 41 may be minimized. Accordingly, heat transfer from the door frame 41 to the hinge housing 110 may be minimized.

The body portion 210 may include the edge provided to correspond to the rear surface 111 of the hinge housing 110. According to the present disclosure, the thermal resistance member 200 may be installed on the rear surface 111 of the hinge housing 110 to allow the area in contact with the hinge housing 110 to be minimized.

The thermal resistance member 200 may be couplable to the hinge housing 110. The thermal resistance member 200 may be couplable to the rear frame 41b. According to the present disclosure, the thermal resistance member 200 may be easily installed in the hinge housing 110 and/or the rear frame 41b. That is, the convenience of installation may be improved.

The hinge housing 100 may include the guide portion 112 provided to guide a coupling position of the thermal resistance member 200. According to the present disclosure, the thermal resistance member 200 may be easily coupled to the rear surface 111 of the hinge housing 110.

The thermal resistance member 200 may include plastic. The thermal resistance member 200 may be formed by injection molding. According to the present disclosure, a heat transfer coefficient of the thermal resistance member 200 may be less than a heat transfer coefficient of the hinge housing 110 and/or the door frame 41, and thus a speed, at which the heat of the door frame 41 is transferred to the door hinge 100, may be reduced.

The door hinge 100 may include the first door hinge 100a, and the second door hinge 100b spaced apart from the first door hinge 100a. The thermal resistance member 200 may include the first thermal resistance member 200a in contact with the first door hinge 100a, and the second thermal resistance member 200b in contact with the second door hinge 100b. According to the present disclosure, the thermal resistance member 200 may be provided according to the number of door hinges 100, thereby individually protecting each door hinge 100.

The thermal resistance member 200 may be disposed in a space in which the door hinge 100 and the door frame 41 are spaced apart from each other. According to the present disclosure, by preventing the door hinge 100 and the door frame 41 from coming into contact, the heat of the door frame 41 may be prevented from being directly transferred to the door hinge 100.

The cooking apparatus 1 according to one embodiment of the present disclosure may include the main body 10 forming the cooking compartment 20, and the door 40 configured to rotate so as to open and close the cooking compartment 20. The door 40 may include the door frame 41 forming the receiving space S, the door hinge 100 disposed in the receiving space S, and the thermal resistance member 200 disposed in the receiving space S of the door frame 41 so as to protect the door hinge 100. According to the present disclosure, the door hinge 100 may be protected by reducing the speed at which heat of the cooking compartment 20 is transferred to the door hinge 100. The thermal resistance member 200 may reduce the speed, at which heat is transferred, by preventing the door hinge 100 and the door frame 41 from coming into contact with each other. Particularly, it is possible to prevent heat, which moves from the cooking compartment 20 to the door frame 41, from being directly transferred to the hinge damper 115 inside the door hinge 100. Accordingly, it is possible to prevent the reduction in the damping force of the hinge damper 115, and to increase the lifespan of the hinge damper 115. The thermal resistance member 200 may reduce the speed, at which heat is transferred, by preventing the hinge housing 110, which surrounds the hinge damper 115, and the rear frame 41b from coming into contact with each other.

The door hinge 100 may include the hinge damper 115 provided to attenuate a moving speed of the door 40, and the hinge housing 110 surrounding the hinge damper 115. The first surface 201 of the thermal resistance member 200 may be disposed to be in contact with the hinge housing 110, and the second surface 202 located opposite to the first surface 201 may be disposed to be in contact with the rear frame 41b. According to the present disclosure, the life span of the hinge damper 115 may be increased by suppressing the heat of the cooking compartment 20 from being transferred to the hinge damper 115. The thermal resistance member 200 may be disposed outside the hinge housing 110, thereby increasing convenience of installation.

The thermal resistance member 200 may include the hollow portion 220, and the body portion 210 forming the hollow portion 220. According to the present disclosure, an area where the thermal resistance member 200 is in contact with the door hinge 100 and/or the door frame 41 may be minimized. Accordingly, heat transfer from the door frame 41 to the hinge housing 110 may be minimized.

The thermal resistance member 200 may be couplable to the hinge housing 110. The hinge housing 100 may include the guide portion 112 provided to guide a coupling position of the thermal resistance member 200. According to the present disclosure, the thermal resistance member 200 may be easily coupled to the hinge housing 110.

The thermal resistance member 200 may include plastic. According to the present disclosure, the heat transfer coefficient of the thermal resistance member 200 may be less than the heat transfer coefficient of the hinge housing 110 and/or the door frame 41, and thus the speed at which the heat of the door frame 41 is transferred to the door hinge 100 may be reduced.

According to the present disclosure, a door hinge may be protected.

Further, a speed at which heat from a cooking compartment is transferred to a door hinge may be reduced.

Further, damage to a hinge damper may be prevented.

While the present disclosure has been particularly described with reference to exemplary embodiments, it should be understood by those of skilled in the art that various changes in form and details may be made without departing from the spirit and scope of the present disclosure.

1. A cooking apparatus comprising:
a main body forming a cooking compartment; and
a door configured to be rotatable to open and close the cooking compartment, the door including:
a door frame,
a door hinge installed on the door frame to connect the door and the main body, the door hinge including a hinge damper to attenuate a rotation speed of the door, and
a thermal resistance member disposed between the hinge damper and the door frame to protect the hinge damper from heat of the cooking compartment.

2. The cooking apparatus of claim 1, wherein
the door frame includes:
a front frame, and
a rear frame at a rear side of the front frame so as to be adjacent to the cooking compartment when the door closes the cooking compartment, and
the thermal resistance member is disposed between the hinge damper and the rear frame.

3. The cooking apparatus of claim 2, wherein
the door hinge includes a hinge housing surrounding the hinge damper, and
the thermal resistance member is disposed between the hinge housing and the rear frame.

4. The cooking apparatus of claim 3, wherein
the hinge housing includes a rear surface facing a direction of the cooking compartment when the door closes the cooking compartment, and
the thermal resistance member is disposed between the rear surface of the hinge housing and the rear frame.

5. The cooking apparatus of claim 4, wherein
the thermal resistance member includes:
a first surface, and
a second surface located opposite to the first surface,
the first surface is in contact with the rear surface of the hinge housing, and
the second surface is in contact with the rear frame.

6. The cooking apparatus of claim 5, wherein
the thermal resistance member includes:
a hollow portion, and
a body portion forming the hollow portion.

7. The cooking apparatus of claim 6, wherein
the body portion includes an edge corresponding to and edge of the rear surface of the hinge housing.

8. The cooking apparatus of claim 4, wherein
the thermal resistance member is couplable to the hinge housing.

9. The cooking apparatus of claim 8, wherein
the hinge housing includes a guide portion to guide a coupling position of the thermal resistance member to the hinge housing.

10. The cooking apparatus of claim 2, wherein
the thermal resistance member is couplable to the rear frame.

11. The cooking apparatus of claim 1, wherein
the thermal resistance member includes plastic.

12. The cooking apparatus of claim 1, wherein
the thermal resistance member is an injection molded member.

13. The cooking apparatus of claim 1, wherein
the door hinge includes:
a first door hinge, and
a second door hinge spaced apart from the first door hinge, and the thermal resistance member includes:
a first thermal resistance member in contact with the first door hinge, and
a second thermal resistance member in contact with the second door hinge.

14. The cooking apparatus of claim 2, wherein
the thermal resistance member is disposed in a space in which the door hinge and the door frame are spaced apart from each other.
